(19) United States
(12) Patent Application Publication
(10) Pub. No.: US 2022/0403611 A1
(43) Pub. Date: Dec. 22, 2022

(54) StopSign-Safe

(71) Applicant: Carlos Lofstedt, Orlando, FL (US)

(72) Inventor: Carlos Lofstedt, Orlando, FL (US)

(21) Appl. No.: 17/351,261

(22) Filed: Jun. 18, 2021

(51) Int. Cl. E01F 9/30; G08G 1/017

(52) U.S. Cl. CPC E01F 9/30; G08G 1/0175

(57) ABSTRACT

A portable or affixed stop sign warning system which enforce stop sign violations through automated photo enforcement with the use of radar and camera technology and incase of any incidence record the event. The system includes a plurality of surface mounted RADAR, computer, camera and video camera which provide the stable, reliable and accurate information necessary, video monitoring, and incident detection. The multi-tracking radar tracks vehicle speed and position as it approaches the stop sign. The system will use the distance, speed over time, acceleration and retardation to capture and automatically validate a stop sign violation. The violation evidence includes but not limited to high-definition picture before the stop line, high-definition picture after the line, close up of the license plate, photos show the stop sign, time, date, speed, and location of incidence.

### BACKGROUND

### Field of the Invention

Embodiments disclosed herein generally relate to methods, apparatus and systems of traffic warning and enforcement systems, and more particularly to an improved fully automated stop sign photo enforcement solution for monitoring and deterring drivers from running a stop sign by photo evidences and notices or warning disbursement.

### Description of the Related Art

The use of traffic signs is known in the prior art. More specifically, traffic signs heretofore devised and utilized for the purpose of controlling traffic are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,598,066 to Wiesemann et al. discloses a two-level security lighting system. U.S. Pat. No. 5,371,489 to Carroll et al. discloses a motion sensing and light flashing apparatus. U.S. Pat. No. 3,593,448 to Schoepf et al. discloses an internally lighted, overhead, traffic sign for streets and highways. U.S. Pat. No. Des. 351,807 to Smith et al. discloses the ornamental design for an illuminated hand-held stop sign. U.S. Pat. No. Des. 315,695 to DeCaro discloses the ornamental design for an illuminated changeable warning signal. U.S. Pat. No. Des. 382,218 to Hall discloses the ornamental design for a hand held stop sign.

There are multiple inventions that have been proposed in prior art in similar regards. However, the current invention proposes a fully automated stop sign photo enforcement solution for monitoring and deterring drivers (m running a stop sign with the idea that Stop sign cameras help discourage stop sign running. The system will detect whether drivers have come to a complete stop before proceeding. The stop sign units use a multi-tracking radar to detect if a vehicle stopped at, rolled through, or ran a stop sign. Notices or warnings are issued to those who fail to stop.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

It is a general object of the present invention to provide an improved form of a fully automated stop sign photo enforcement solution for monitoring and deterring drivers from running a stop sign with the idea that Stop sign cameras help discourage stop sign running.

It is another object to provide an improved, convenient and safe stop sign photo enforcement technology intended to use photo enforcement to monitor and enforce the rules of the road and stop sign.

It is another object to disclose a method to introduce a universal device which will detect whether drivers have come to a complete stop before proceeding. The stop sign units use a multi-tracking radar to detect if a vehicle stopped at, rolled through, or ran a stop sign.

It is also the objective of the invention to use a variety of technologies to accomplish this including multi-tracking radar, and/or video camera analytics to capture incidence and send notices or warnings.

It is also the objective of the system to provide an architecture which is easy to use and has long life.

According to another aspect, it is also the objective of the invention to provide technology which can be affixed or can be portable as well.

Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide a system which provides a stop sign non-adherence enforcement and warning system which is self-contained, easily retrofitted to existing locations and designed to use photo enforcement to monitor and enforce the rules of the road.

As per further embodiments of the invention, the system uses Dual Doppler Positional Radar. This advanced radar device effortlessly and accurately tracks the speed and position of multiple vehicles across several lanes simultaneously. The Radar provides the technological core of intersection enforcement solutions and also provides the stable, reliable and accurate information necessary, video monitoring, and incident detection. The vehicle detection is completely non-intrusive and never requires intrusion into the road surface.

The multi-tracking radar as per its additional embodiments tracks vehicle speed and position as it approaches the stop sign. The system will use the distance, speed over time, acceleration and retardation to capture and automatically validate a stop sign violation.

The first violation picture as per its preferred embodiments shows violating vehicle BEFORE the stop line, showing the stop sign, the vehicle, and the license plate. The second violation picture shows violating vehicle AFTER the stop line, showing the stop sign, the vehicle, and the license plate. Video evidence is included to verify the violation. The violation evidence includes picture before the line, picture after the line, close up of the license plate, photos show the stop sign, time, date, speed, and location, also included is video evidence of the violation.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A stop sign enforcement system allowing automatically capturing and issuance of warning and notices of stop sip violations with an enforcement system with the use of radar and camera technology said apparatus co uprising;:
a roadway, said roadway having a surface;
a stop sign or stop sips mounted on said roadway surface and extending at least some distance across said roadway and above said roadway surface to at least partially designate a stop sign crossing; and
dual doppler positional radar which tracks vehicle speed and position of multiple vehicles across several lanes simultaneously;
The Stop Sign-Safe system as per claim I, there if violation detected the camera takes the picture of incident;
The Stop Sign-Safe system as per claim I, where the violation evidence includes picture before the stop line, picture after the line, close up of the license plate, photos show the stop sign, time, date, speed, and location, also included is video evidence of the violation.
